(19) United States
(12) Patent Application Publication
(10) Pub. No.: US 2015/0356696 A1
(43) Pub. Date: Dec. 10, 2015

(54) AUTOMATED DOCUMENT FILLING AND SIGNING PROCESS

(71) Applicant: Oz Labs Ltd., Maccabim (IL)

(72) Inventor: Ran Oz, Maccabim (IL)

(21) Appl. No.: 14/299,019

(22) Filed: Jun. 9, 2014

(51) Int. Cl. G06Q 50/18; G06Q 10/10

(52) U.S. Cl. CPC G06Q 50/18; G06Q 10/10

(57) ABSTRACT

A system that includes a processor and an interface, wherein the interface is arranged to receive, content item information indicative of content items to be filled in multiple locations of a document, to receive content provider information about at least one content provider that is expected to provide the content items and to send, using the content provider information, to a system of each one of the least one content provider, a request to provide at least one content item associated with the content provider; and wherein the processor is arranged to verify a completion of a provision of all the content items.

### BACKGROUND OF THE INVENTION

Many tools are providing the ability to “sign” a Portable Document Format (PDF) document by enabling the graphics of the signature into the PDF. While this is an easy way to sign, it is very unsecure as anyone can digitally “copy” a signature and use it in illegal way. As a result many institutes are now reluctant to get documents that were signed electronically or are asking another measure of manual authentication like calling the customer smartphone and verifying the signature. (E.g. Wire transaction).

The process and workflow of managing the signature process of a document is fully manual. Party A is generating a form, that need to be signed by one or few individuals in many locations in the document and then the signed document needs to be transferred to party B. The entire workflow is done manually where typically the document is physically sent (by email from one person to another and then filed somewhere by the last person).

There are few cases were few people need to sign the same PDF document (E.g., a round of investment). In order not to delay the process, law firms tend to collect only signature pages from the different individuals. So in case where 10 different signatures are needed on a page, typically the law firm will collect 10 different pages with a single signature on each page. Again, signatures can be digitally used illegally here as well.

In a document where the same individual needs to sign on many locations, there are many times where the person signing the doc forgets to sign in one place or more. There is no automated process that helps the signing person not to forget signatures. There is also no automated process to help the person receiving the document to verify that all locations were covered.

In many case, PDF forms are filled with wrong data (address, phone number). The receiver of the documents needs to look for mistakes manually.

There is a growing need to provide a fully automated system for managing and verifying the filling of a document.

### SUMMARY

According to an embodiment of the invention there may be provided a method, a system and a computer readable medium for filling a document, wherein the filling may include signing the document.

According to an embodiment of the invention there may be provided a non-transitory computer readable medium that stores instructions that once executed by a computer cause the computer to execute the stages of receiving, by the computer, content item information indicative of content items to be filled in multiple locations of a document; receiving, by the computer, content provider information about at least one content provider that is expected to provide the content items; sending, by the computer and using the content provider information, to a system of each one of the least one content provider, a request to provide at least one content item associated with the content provider; and verifying, by the computer, a completion of a provision of all the content items. The verifying and sending may be executed without user intervention.

The non-transitory computer readable medium may store instructions for verifying the completion of the provision of all of the content items by checking if a content item that should have been provided by a content provider was not provided by the content provider; and sending to a system of the content provider a request to receive the missing content item.

The non-transitory computer readable medium may store instructions for showing to a content provider out of the at least one content provider, all content items that should be provided by the content provider.

The non-transitory computer readable medium wherein at least one content item is a signature.

The non-transitory computer readable medium may store instructions for creating content item validation information for a content item, wherein a reception of the content item validation information triggers a validation process of the content item. The creating may be executed without human intervention.

The content item validation information may be in a form of a Quick Response (QR) code.

The content item validation information comprises information about (a) the location of the content item in a document, (b) content provider information related to an identity of a content provider that should have provided the content item, and (c) contact information for contacting a system of the content provider during the validation process.

The non-transitory computer readable medium may store instructions for monitoring a provision of content items to provide monitoring results and sending, by the computer, status information indicative of a status of a document based on the monitoring results.

According to an embodiment of the invention there may be provided a method that is executed by a computer (any form of a computerized system) receiving, by the computer, content item information indicative of content items to be filled in multiple locations of a document; receiving, by the computer, content provider information about at least one content provider that is expected to provide the content items; sending, by the computer and using the content provider information, to a system of each one of the least one content provider, a request to provide at least one content item associated with the content provider; and verifying, by the computer, a completion of a provision of all the content items. The verifying and sending may be executed without user intervention.

The method may include verifying the completion of the provision of all of the content items by checking if a content item that should have been provided by a content provider was not provided by the content provider; and sending to a system of the content provider a request to receive the missing content item.

The method may include showing to a content provider out of the at least one content provider, all content items that should be provided by the content provider.

The at least one content item may be a signature.

The method may include creating content item validation information for a content item, wherein a reception of the content item validation information triggers a validation process of the content item. The creating may be executed without user intervention.

The content item validation information may be in a form of a QR code.

The content item validation information may include information about (a) the location of the content item in a document, (b) content provider information related to an identity of a content provider that should have provided the content item, and (c) contact information for contacting a system of the content provider during the validation process.

The method may include monitoring a provision of content items to provide monitoring results and sending, by the computer, status information indicative of a status of a document based on the monitoring results.

According to an embodiment of the invention there may be provided a system that comprises a processor and an interface, wherein the interface may be arranged to receive, content item information indicative of content items to be filled in multiple locations of a document, to receive content provider information about at least one content provider that is expected to provide the content items and to send, using the content provider information, to a system of each one of the least one content provider, a request to provide at least one content item associated with the content provider; and wherein the processor may be arranged to verify a completion of a provision of all the content items. The verifying and sending may be executed without user intervention.

The processor may be arranged to verify the completion of the provision of all of the content items by checking if a content item that should have been provided by a content provider was not provided by the content provider; and sending to a system of the content provider a request to receive the missing content item.

The processor may be arranged to showing to a content provider out of the at least one content provider, all content items that should be provided by the content provider.

The at least one content item may be a signature.

The processor may be arranged to create content item validation information for a content item, wherein a reception of the content item validation information triggers a validation process of the content item. The creating may be executed without user intervention.

The content item validation information may be in a form of a QR code.

The content item validation information may include information about (a) the location of the content item in a document, (b) content provider information related to an identity of a content provider that should have provided the content item, and (c) contact information for contacting a system of the content provider during the validation process.

The processor may be arranged to monitor a provision of content items to provide monitoring results and wherein the interface may be arranged to send status information indicative of a status of a document based on the monitoring results.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a method according to an embodiment of the invention;

FIG. 2 illustrates a method according to an embodiment of the invention;

FIG. 3 illustrates a method according to an embodiment of the invention;

FIG. 4 illustrates a method according to an embodiment of the invention;

FIG. 5 illustrates various systems and a network according to an embodiment of the invention;

FIG. 6 illustrates various data elements according to an embodiment of the invention;

FIG. 7 illustrates various data elements according to an embodiment of the invention; and

FIG. 8 is a timing diagram according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

According to an embodiment of the invention there may be provided a system, a method and/or a non-transitory computer readable medium for allowing a user to create a document and for allowing one or more users to provide one or more content items (such as a signature) during a document filling in process. The filling in process (also termed filling process) includes receiving content items from one of more users.

A content item may include text, graphics, symbols and the like. The content is filled in an electronic and/or magnetic/ and/or optical manner.

For simplicity of explanation various examples refer to signatures that should be provided by a user. It is noted that the signature is an example of a content item that may be provided by the user during a document filling process.

A user that participates in the creation of the document is referred to as a document initiator. A user that should provide a content item (such as his signature) to the document during the document filling process is referred to as a content provider. It is noted that the document initiator may also be a content provider although in some cases the document initiator differs from each one of the content providers.

According to an embodiment of the invention there may be provided a system, a method and/or a non-transitory computer readable medium that allow at least one out of (a) management of a document filling process including verification that all content items was provided by intended content providers, (b) verification of a content item provision, (c) receiving a status of the document filling process, (d) sending reminders and setting timing constraints for filling the document.

The system, method and/or non-transitory computer readable medium may automatically manage the workflow of signing documents all the way from start to end.

The system, method and/or non-transitory computer readable medium may alert a content provider (such as a signing user) if a specific signature (or another content item) is forgotten.

The system, method and/or non-transitory computer readable medium may prevent a content provider from forgetting about a signature box (forgetting to provide a signature).

The system, method and/or non-transitory computer readable medium may alerts a document initiator about signatures that a content provider decided not to provide a content item (for example—decided not to sign).

The system, method and/or non-transitory computer readable medium may provide to a content provider (such as a signing user) a complete status view of all documents (from different sources) that were signed (or of which another content item was provided) by the content provider and/or of document that are waiting for the content provider signature (or another content item).

The system, method and/or non-transitory computer readable medium may provide an entity such as a document initiator and/or a user that collects signed documents to view the status of each document.

The system, method and/or non-transitory computer readable medium may provide real-time verification/confirmation of a signed document.

The system, method and/or non-transitory computer readable medium may use a viral process to spread it across users and organizations.

The system, method and/or non-transitory computer readable medium may send one or more reminders based on due dates of signatures (or another content item).

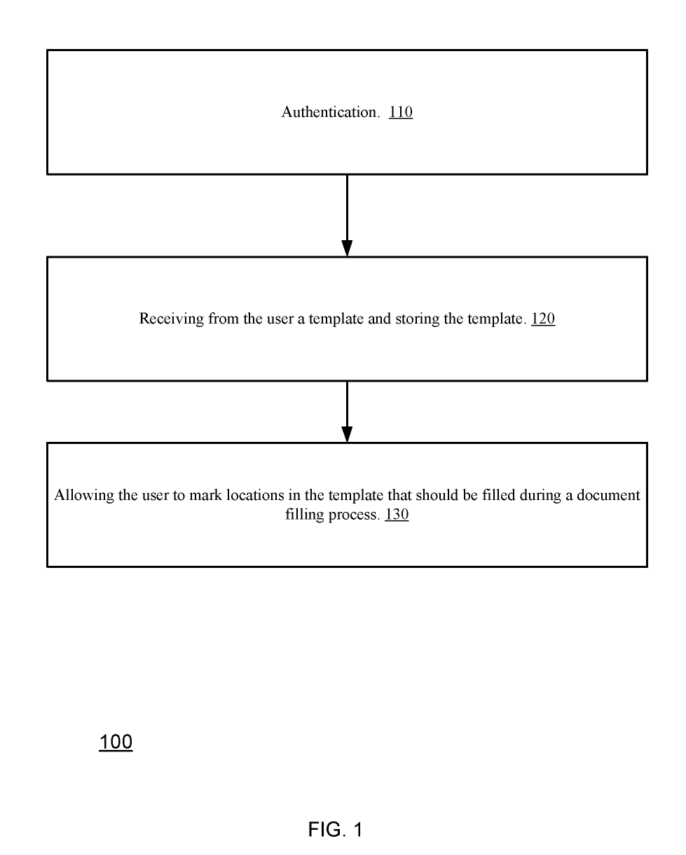

FIG. 1 illustrates method 100 according to an embodiment of the invention.

Method 100 may be performed by a computerized system and is aimed to allow the upload of a new template. It is noted that templates may also be generated automatically and/or retrieved from sources (such as data bases) without user intervention.

Method 100 may start by stage 110 of authentication. A user who wishes to upload a template may be required to authenticate himself.

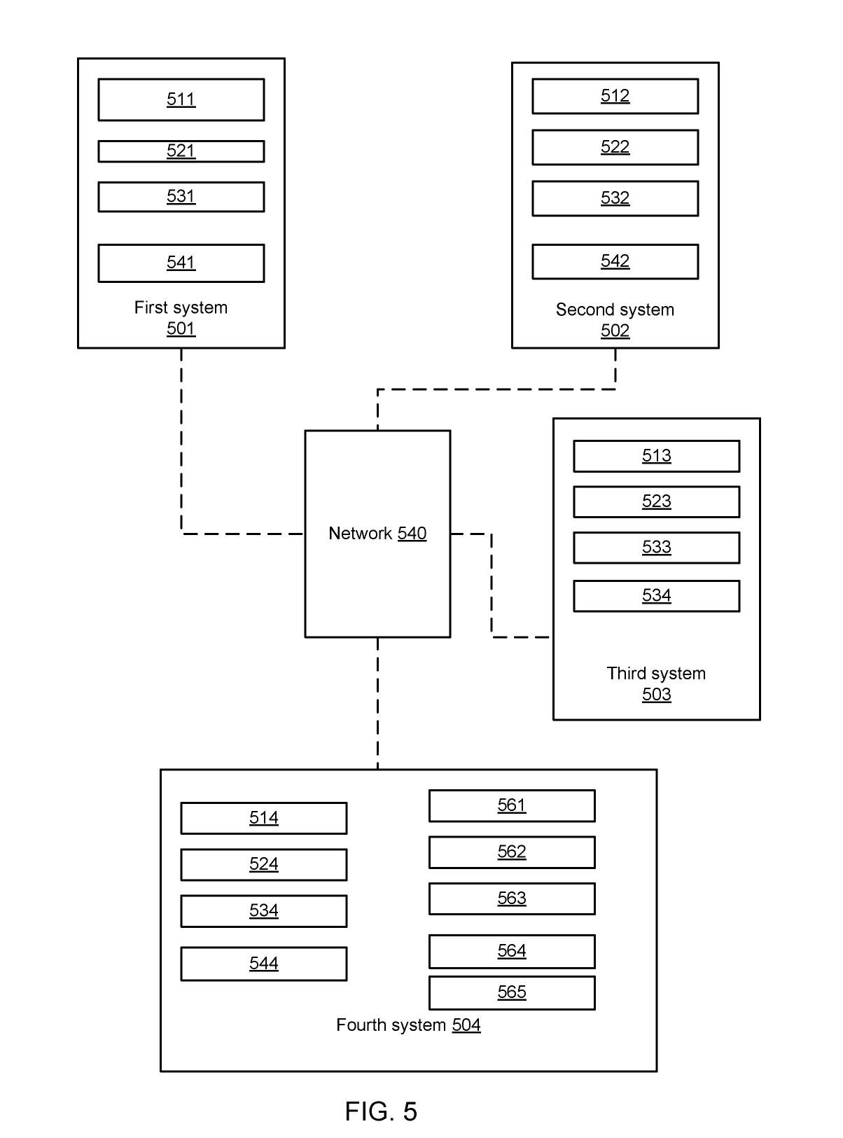

The authentication can include any prior art authentication method including a login and password based authentication, biometric authentication and the like. A user may be requested to browse to a certain web site (referred to as www.filledindocuments.com) in order to perform the authentication. The certain web site (www.filledindocuments.com) may be hosted in a cloud environment or any other computerized environment. FIG. 5 illustrates a fourth system 504 that may host the certain web site.

Stage 110 (assuming successful authentication) may be followed by stage 120 of receiving from the user a template and storing the template. The template is uploaded by the computerized system. The computerized system may manage multiple templates per user.

The template may be any type of document. For example it may be a blank non-disclosure agreement (NDA) in which the parties to the NDA agreement are not listed.

Stage 120 may be followed by stage 130 of allowing the user to mark locations in the template that should be filled during a document filling process. This stage may include receiving instructions from the user about locations in the template that should be filled by a content item (for example—at least one out of names, addresses, identification information, check marks and signatures) during the document filling process. For example—the user may mark location in which parties of the NDA should sign and/or provide other content items.

Stage 130 may include displaying to the user the template and allowing the user to mark the locations. The user may also define which type of content item should be filled in each location.

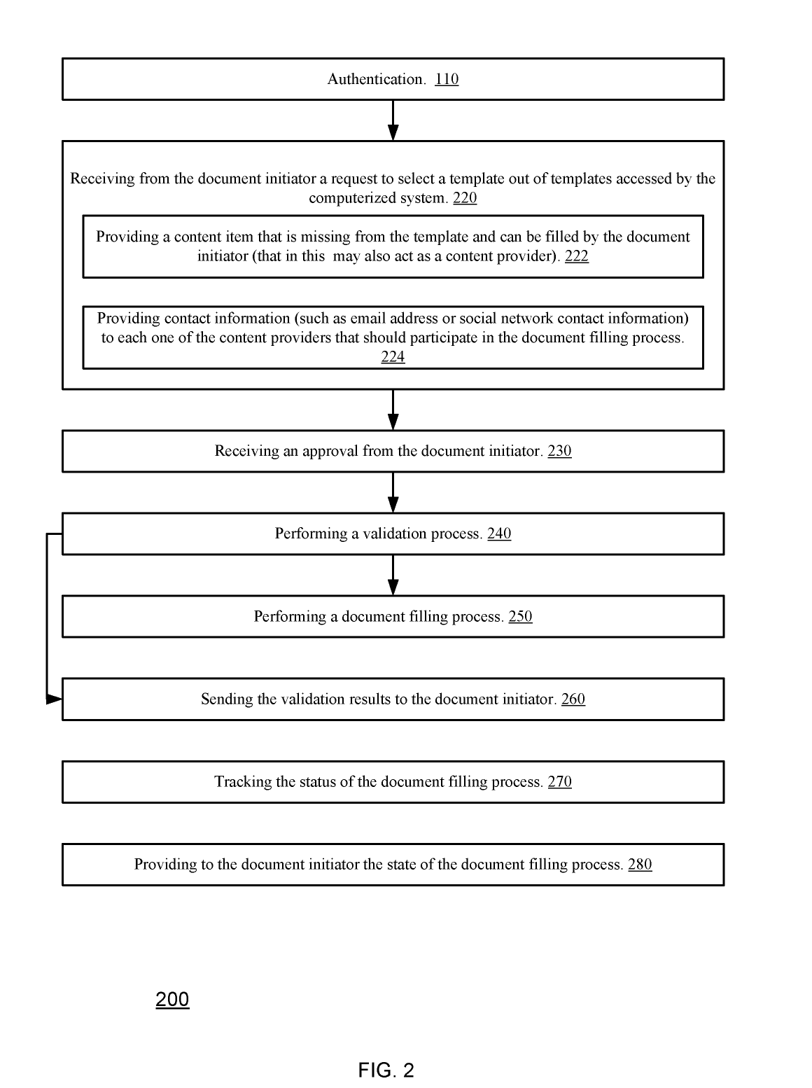

FIG. 2 illustrates method 200 according to an embodiment of the invention.

Method 200 may be performed by a computerized system and is aimed for allowing generating a document based upon a template that was loaded during stage 100.

Method 200 may start by stage 110 of authentication of the document initiator. The document initiator may be requested to sign to the web site www.filledindocuments.com and be authenticated.

Stage 110 may be followed by stage 220 of receiving from the document initiator a request to select a template out of templates accessed by the computerized system.

Stage 220 includes allowing the document initiator to perform at least one out of stages 222 and 224.

Stage 222 may include providing a content item that is missing from the template and can be filled by the document initiator (that in this stage may also act as a content provider). This content item may be, for example, identity of other users, addresses of other users.

This stage may also include providing control information such as order of content item provision (for example a signature of one content provider may precede a signature of another a content provider), reminders to be sent to content providers (time of sending the reminders, content item reminder, type of reminder and the like), dates for providing the content item by the content providers and the like (for example—due date for every signature or for a group of signatures in the document).

Stage 224 may include providing contact information (such as email address or social network contact information) to each one of the content providers that should participate in the document filling process. For example—the email of each content provider may be included in each location in the document in which that content provider should sign the document during the document filling process.

For example—the document initiator may retrieve the blank NDA, fill in the date, the identity and address of the parties and then mark the locations in which the parties have to sign the agreement. It is noted that various content items (for example—the printed name of a signer and his title) can be provided by the document initiator of left to be filled by one or more party of the NDA.

Stage 220 may be followed by stage 230 of receiving an approval from the document initiator.

Stage 230 may be followed by stage 240 of performing a validation process—for example checking if the document initiator provided all the required information (for example—for each missing content item there is provided either the content item or contact information of a content provider that should provide the content item).

If the validation succeeds stage 240 may be followed by stage 250 of performing a document filling process. Stage 250 may include methods 300 and/or 400 according to various embodiments of the invention.

If the validation fails then stage 240 may be followed by stage 260 sending the validation results to the document initiator and jumping to stage 220 for getting more information.

Method 200 may also include stage 270 of tracking the status of the document filling process. Stage 270 may be followed by stage 280 of providing to the document initiator the state of the document filling process.

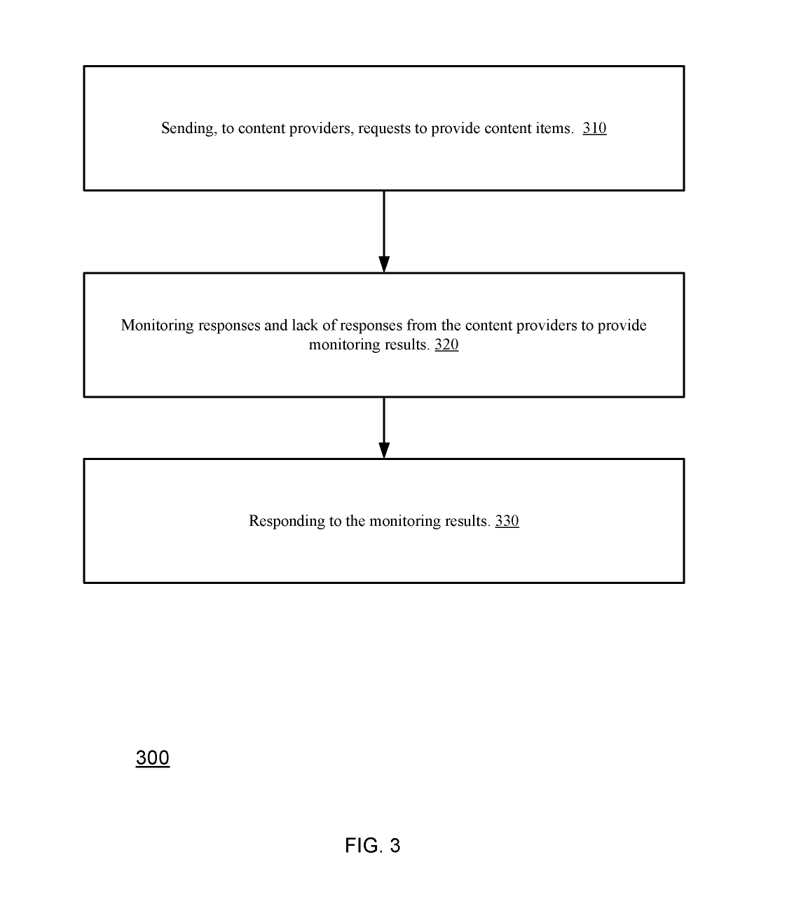

FIG. 3 illustrates a method 300 according to an embodiment of the invention. This method is aimed to fill a document.

Method 300 may start by stage 310 of sending, to content providers, requests to provide a content item. The requests may include information about the requested content item, the document that should be filled in, other content providers that should provide a content item, the status of the document filling process and the like.

It is noted that stage 310 may include sending to a single provider a request to fill in a single content item.

Additionally or alternatively the requests may include information required for providing the content item—such as the address of the certain website www.filledindocuments.com that should be browsed to in order to provide the content item.

The requests are generated in response to information (such as contact information and requested content item) provided during method 200.

For example stage 310 may include sending emails to the email addresses of all the content providers that should sign the document. If method 200 defined a signing order then the requests are sent to the content providers according to their order.

Stage 310 may be followed by stage 320 of monitoring responses and lack of responses from the content providers to provide monitoring results.

The monitoring may include checking when a content item was provided, from which content provider a content item was provided, determining that certain content item was not provided yet, whether content providers received requests and reminder and the like.

Stage 320 may be followed by stage 330 of responding to the monitoring results.

For example—if a content provider authenticated to the certain web site www.filledindocuments.com and provided the requested content item (the requested content item may be provided anytime or within a predefined time period) then the responding may check whether additional content item should be provided from one of the one or more content providers and if so sending requests to obtain the missing content item.

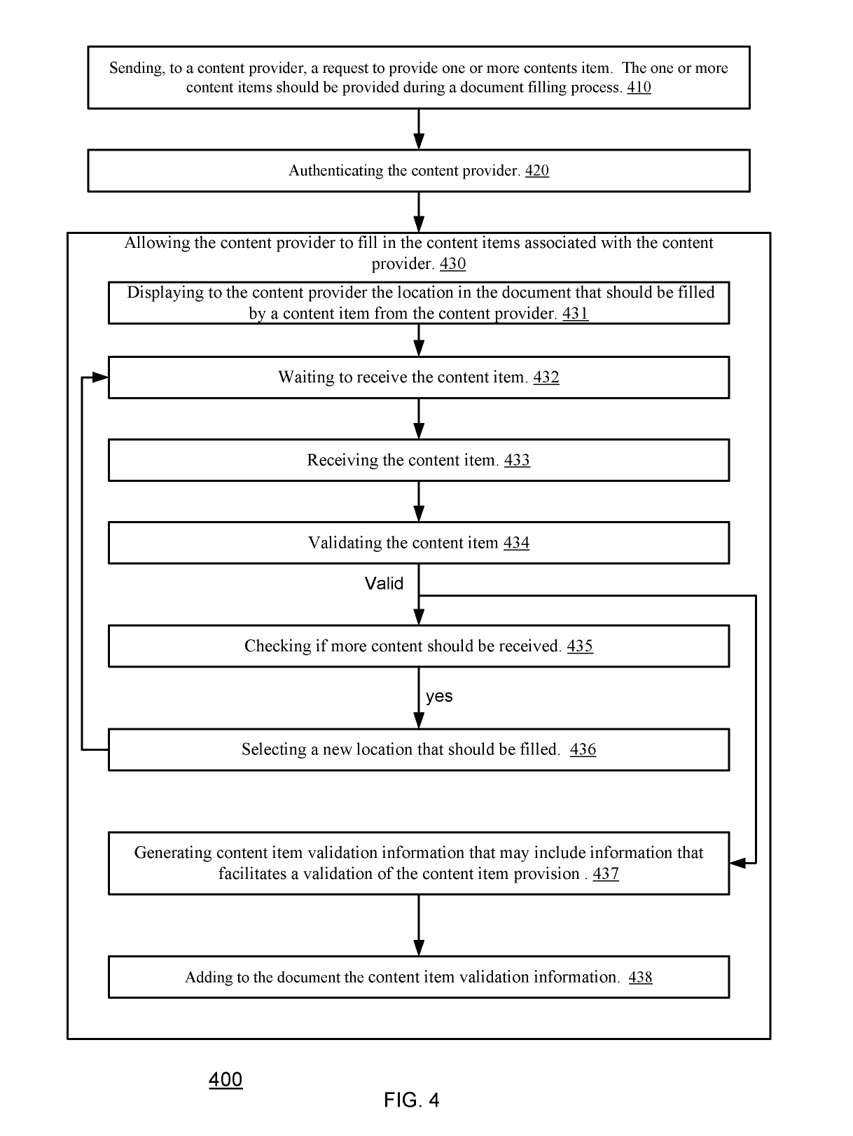

FIG. 4 illustrates a method 400 according to an embodiment of the invention. This method includes an interaction with a single content provider during the document filling process.

Method 400 may start by stage 410 of sending, to a content provider, a request to provide a content item. The content item should be provided during a document filling process.

Stage 410 may be followed by stage 420 authenticating the content provider. The authentication may require the content provider to browse to the certain web site www.filledindocuments.com. If the content provider is not registered to the certain web site (and/or to the document filling process) the content provider may be requested to register to the certain website (and/or to the document filling process).

Stage 420 may be followed by stage 430 of allowing the content provider to fill the content item associated with the content provider.

Stage 430 may include at least one of stage 431-438.

Stage 431 of displaying to the content provider the location in the document that should be filled by a content item from the content provider.

Stage 432 of waiting to receive the content item.

Stage 433 of receiving the content item.

Stage 434 of validating the content item (if validation is required—for example in the case of zip codes, phone number).

The validation may be limited to formalities (for example—the number of digits of a phone number) or may be more extensive and include checking other data sources (such as social networks) to see whether the content item is valid or not (for example checking a match between a name of the content provider and the address provided by him) It is noted that if the content item is not provided (or not provided within a predefined time window) then the content provider may receive an appropriate notification and be requested to provide the content item.

Stage 435 of checking if more content items should be received (for example—more signatures are required) and if so—jumping to stage 436 of selecting a new location that should be filled. Stage 436 may be followed by stage 431.

Stage 437 of generating content item validation information that may include information that facilitates a validation of the content item. Each content item may be associated with content item validation information that may include information about (a) the location of the content item, (b) content provider information related to the identity of the content provider that should have provided the content item, and (c) and contact information that allows a computerized system to contact a system of the content provider during the validation process.

The location may be indicative of the exact location (for example page and line number, pixel of image of a page of the document) within the document and/or may be indicative of the relationship between the location and other locations to be filled by content providers. For example—the content item validation information may identify a content item as being the third signature of the document and that the signature should be provided by a second content provider.

Stage 348 of adding to the document (preferably at the location that was filled with the content item) the content item validation information. The content item validation information should be visible (for example—it may be a bar code, a QR code and the like).

For example, stages 347 and 348 may include adding a QR code that includes the content item validation information (such as URL). Accordingly, at any given time in the future, the document can be scanned and the QR code may include information that triggers sending of a query to the content provider (that is associated with the content item) in order to allow the content provider to approve (or disapprove) that he provided the content item.

If the content provider is of the opinion that he did not provided the content item (for example—did not sign the document at the certain location) then he (the content provider) may notify the user that scanned the document or any other party.

The content provider and any person that watches the document may have a computer (such as a smartphone) that may execute an application (or any other form of instructions executable by the computer) that may be used in order to allow the person and the content provider to verify that the content provider confirm his signature (confirm that he provided the content item). Once the QR code is scanned by a person the application executed by the persons computer sends a message (via email, messaging applications, social network, WhatsApp Messenger™ and the like) to the content providers computer that in turn displays to the content provider information about the content item (such as signature) that was supposed to be provided by the content provider and the content provider may respond by approving or rejecting the presumption that he provided the content item.

FIG. 5 illustrates four systems 501, 502, 503 and 504 and a network 540 that is coupled to all of the systems 501-504 according to an embodiment of the invention.

Each system out of systems 501-504 may be a computerized system such as a laptop, a desktop, a game console, a smartphone, a media player, a mobile phone, a communication device, a server and the like. These systems may be coupled to each other by network 540. Network may be a wired network, a wireless network, a combination of wired and wireless networks, a local area network, a large area network, the Internet, and the like.

First system 501 may include a processor 511, a memory module (that is non-transitory) 521, and an interface 531. Processor 511 may be arranged to execute instructions 541.

Second system 502 may include a processor 512, a memory module (that is non-transitory) 522, and an interface 532. Processor 512 may be arranged to execute instructions 542.

Third system 503 may include a processor 513, a memory module (that is non-transitory) 523, and an interface 533. Processor 513 may be arranged to execute instructions 543.

Fourth system 504 may include a processor 514, a memory module (that is non-transitory) 524, and an interface 534. Processor 514 may be arranged to execute instructions 544.

Each interface (531, 532, 533 and 534) may include a receiver and/or a transmitter and may include a man machine interface such as a keyboard, a display, a touch screen, a microphone for voice activation, a camera for motion activation, and the like.

Each processor (511, 512, 513 and 514) may be a general purpose processor, a dedicated processor (such as a digital signal processor), a hardware accelerator and the like.

Instructions (541, 542, 543 and 544) may be in the form of software, code, firmware, middleware, and the like. The instructions cause any one of processors 511, 512, 513 and 514 to execute any method illustrated in the specification.

Assuming that the first, second and third systems 501, 502 and 503 are smartphones then instructions 541, 542 and 543 respectively may be a part of an application.

The fourth system 504 is assumed to be a server (or other computerized system) that supports the certain website www.filledindocuments.com.

It is shown as including a template data structure 561 that stores templates, a documents data structure 562 that stores documents, a status data structure 563 that stores information about the status of each task associated with any document, a task data structure 564 that stores tasks to be executed during the filling of any of the document and a log data structure 565 that may stores a log of events that occurred in relation to the documents.

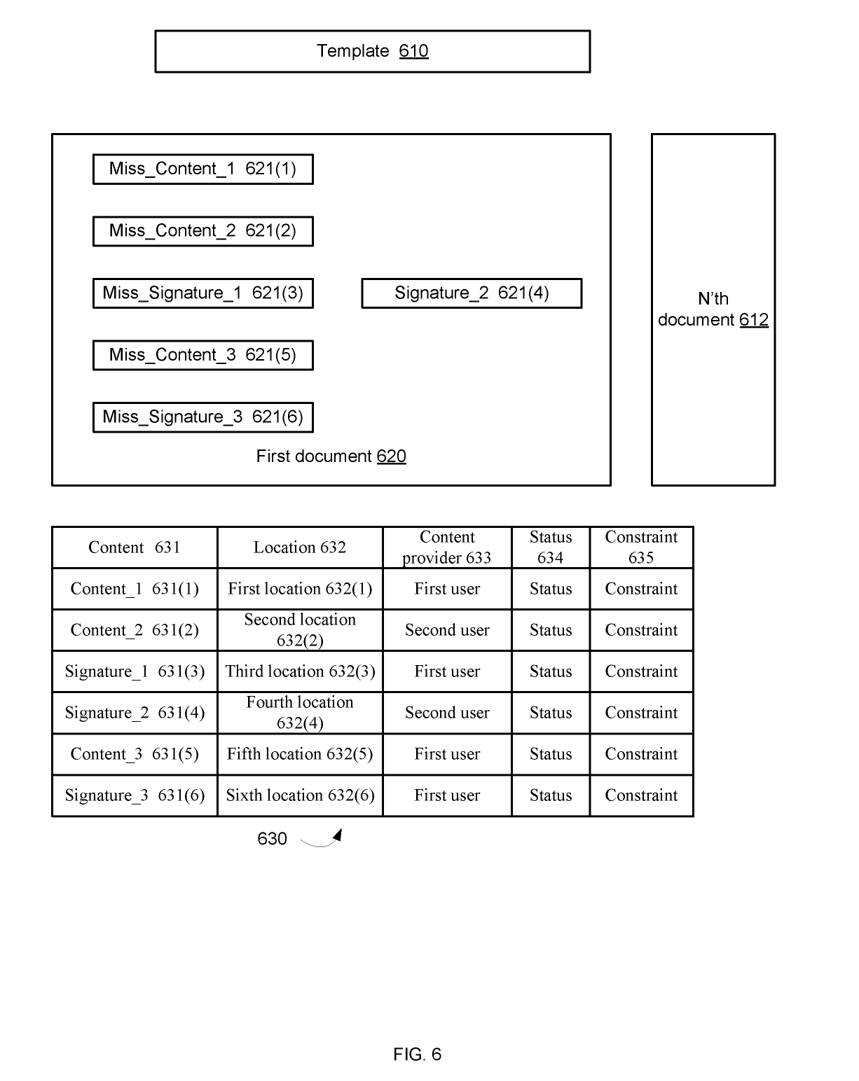

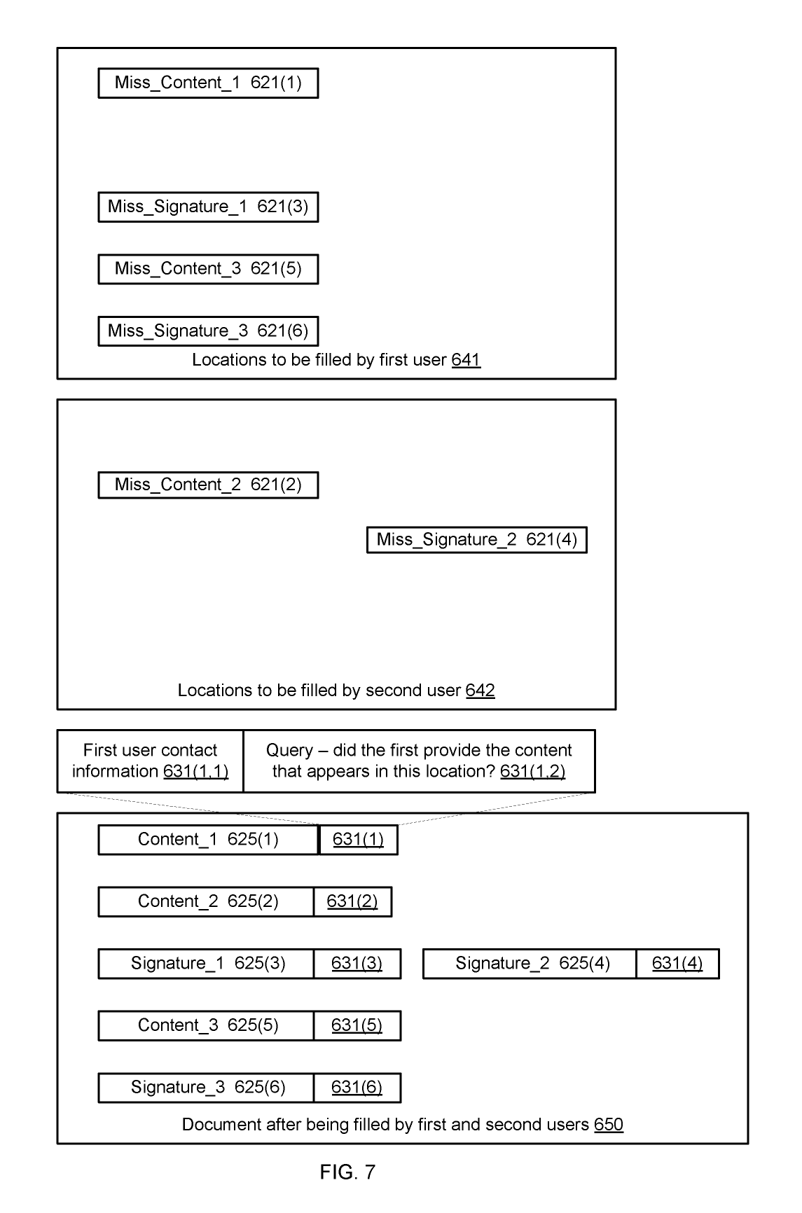

FIG. 6 and FIG. 7 illustrate various data elements according to an embodiment of the invention.

It is assumed that the template data structure 561 includes a template of a document (for example a general non-disclosure agreement (NDA). This template is used to generate multiple documents such as a first document 620 and an N'th document 612, N being a positive integer. First document 620 is generated by the user of the first system 501—which is regarded as a document initiator.

The document initiator determines that the first document 620 should be filled by a first user (first a content provider) of second system 502 and by a second user (second a content provider) of third system 503.

The document initiator defines that the first user should supply the following content items:
a. A content item “Miss_content_{—}1 621(1)” that differs from a signature and should be provided to a first location 632(1) of the first document.
b. Signature “Miss_signature_{—}1 621(3)” that should be provided to a third location 632(3) of the first document.
c. A content item “Miss_content_{—}3 621 (5)” that differs from a signature and should be provided to a fifth location 632(5) of the first document.
d. Signature “Miss_signature_{—}1621(6)” that should be provided to a sixth location 632(6) of the first document.

The document initiator defines that the second user should supply the following content items:
a. A content item “Miss_content_{—}2 621(2)” that differs from a signature and should be provided to a second location 632(2) of the first document.
b. Signature “Miss_signature_{—}2 621(4)” that should be provided to a fourth location 632(4) of the first document.

The location of the missing content item, the identity of the content providers, the status of the content item provision (a content item was provided or not), and constraints such as timing constraints (when to provide a content item) are illustrated in data structure 630 and its columns 631, 632, 633, 634 and 635.

While FIG. 6 illustrates the entire first document 620—FIG. 7 illustrates the locations 641 that should only be filled by the first user (shown to the first user during a document filling process) and the locations 642 that should only be filled by the second user (shown to the second user during a document filling process).

FIG. 7 also illustrates a first document after being filled 650. The filled first document 650 include, in addition to the requested content item, content item validation information 631(1)-631(6) that is visible and may be scanned in order to perform a content item provision validation process.

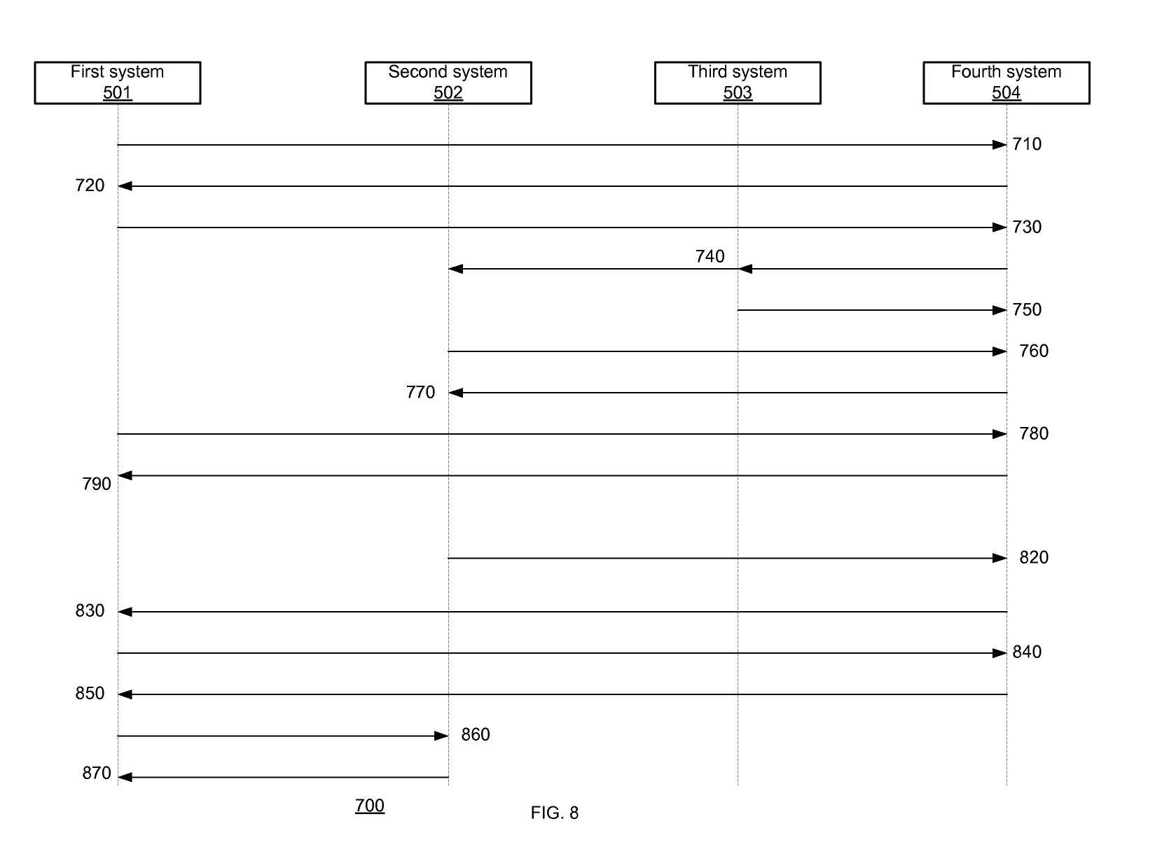

FIG. 8 is a timing diagram according to an embodiment of the invention.

Timing diagram 700 illustrates various events executed by the various systems 501-504 of FIG. 5. An arrow from one system to the other illustrates a communication from one system to the other.

Table 1 provides a concise description of the events:

TABLE 1

| | Source | Target | |
|---|---|---|---|
| Event # | system | system | Event |
| 710 | 501 | 504 | Request to receive a template |
| 720 | 504 | 501 | Provision of the requested template |
| 730 | 501 | 504 | Instructions for creating a document from the |
| | | | template |
| 740 | 504 | 502, | Request to provide a content item to |
| | | 503 | document |
| 750 | 503 | 504 | Part of requested content items |
| 760 | 502 | 504 | Requested content item |
| 770 | 504 | 503 | Request to provide a missing content item |
| 780 | 501 | 504 | Request to receive status of document filling |
| | | | process |
| 790 | 504 | 501 | Status of the document filling process |
| 820 | 502 | 504 | Provision of missing content item |
| 830 | 504 | 501 | Document filling process completion |
| | | | message |
| 840 | 501 | 504 | Request to retrieve filled in document |
| 850 | 504 | 501 | Filled in document |
| 860 | 501 | 502 | Validation query following a scanning of |
| | | | content item validation information |
| 870 | 502 | 501 | Response to validation query |

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A non-transitory computer readable medium that stores instructions that once executed by a computer cause the computer to execute the stages of:
receiving, by the computer, content item information indicative of content items to be filled in multiple locations of a document;
receiving, by the computer, content provider information about at least one content provider that is expected to provide the content items;
sending, by the computer and using the content provider information, to a system of each one of the least one content provider, a request to provide at least one content item associated with the content provider; and
verifying, by the computer, a completion of a provision of all the content items.

2. The non-transitory computer readable medium according to claim 1 that stores instructions for verifying the completion of the provision of all of the content item by:
checking if a content item that should have been provided by a content provider was not provided by the content provider; and
sending to a system of the content provider a request to receive the missing content item.

3. The non-transitory computer readable medium according to claim 1 that stores instructions for showing to a content provider out of the at least one content provider, all content items that should be provided by the content provider.

4. The non-transitory computer readable medium according to claim 1 wherein at least one content item is a signature.

5. The non-transitory computer readable medium according to claim 1 that stores instructions for creating content item validation information for a content item, wherein a reception of the content item validation information triggers a validation process of the content item.

6. The non-transitory computer readable medium according to claim 5 wherein the content item validation information is in a form of a QR code.

7. The non-transitory computer readable medium according to claim 5 wherein the content item validation information comprises information about (a) the location of the content item in a document, (b) content provider information related to an identity of a content provider that should have provided the content item, and (c) contact information for contacting a system of the content provider during the validation process.

8. The non-transitory computer readable medium according to claim 1 that stores instructions for monitoring a provision of content items to provide monitoring results and sending, by the computer, status information indicative of a status of a document based on the monitoring results.

9. A method to be executed by a computer the method comprises:
receiving, by the computer, content item information indicative of content items to be filled in multiple locations of a document;
receiving, by the computer, content provider information about at least one content provider that is expected to provide the content items;
sending, by the computer and using the content provider information, to a system of each one of the least one content provider, a request to provide at least one content item associated with the content provider; and
verifying, by the computer, a completion of a provision of all the content items.

10. The method according to claim 9, comprising verifying the completion of the provision of all of the content item by:
checking if a content item that should have been provided by a content provider was not provided by the content provider; and
sending to a system of the content provider a request to receive the missing content item.

11. The method according to claim 9, comprising showing to a content provider out of the at least one content provider, all content items that should be provided by the content provider.

12. The method according to claim 9 wherein at least one content item is a signature.

13. The method according to claim 9 comprising creating content item validation information for a content item, wherein a reception of the content item validation information triggers a validation process of the content item.

14. The method according to claim 13 wherein the content item validation information is in a form of a QR code.

15. The method according to claim 13 wherein the content item validation information comprises information about (a) the location of the content item in a document, (b) content provider information related to an identity of a content provider that should have provided the content item, and (c) contact information for contacting a system of the content provider during the validation process.

16. The method according to claim 9, comprising monitoring a provision of content items to provide monitoring results and sending, by the computer, status information indicative of a status of a document based on the monitoring results.

17. A system that comprises a processor and an interface, wherein the interface is arranged to receive, content item information indicative of content items to be filled in multiple locations of a document, to receive content provider information about at least one content provider that is expected to provide the content items and to send, using the content provider information, to a system of each one of the least one content provider, a request to provide at least one content item associated with the content provider; and wherein the processor is arranged to verify a completion of a provision of all the content items.
